(19) United States
(12) Patent Application Publication
(10) Pub. No.: US 2005/0060281 A1
(43) Pub. Date: Mar. 17, 2005

(54) Rule-based content management system

(76) Inventors: Tim Bucher, Los Altos, CA (US); James A. Savage, San Jose, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/899,801

(22) Filed: Jul. 26, 2004

Related U.S. Application Data
(60) Provisional application No. 60/491,449, filed on Jul. 31, 2003.

(51) Int. Cl. G06F 17/30

(52) U.S. Cl. 707/1

(57) ABSTRACT

A system, method and software for rule-based content management are provided that can be employed in a variety of computing environments. Examples of such computing environments include a single computer, computer network environments, and client-server environments. Generally, the method involves the use of rules to effect content management. One example of a rule defines relationships between and among a content event, predetermined content, and action to be taken concerning the predetermined content. Initially, the method involves detection of the occurrence of a content event such as, for example, creation or modification of a file at some location in the environment. After the content event is detected, the associated content is identified. The rules applicable to such content are then consulted and the various actions specified by such rules, such as backup and distribution of the content for example, are implemented with respect to the identified content.

### CROSS-REFERENCE TO RELATED APPLICATIONS

This application claims the benefit of U.S. Provisional Patent Application Ser. No. 60/491,449, filed Jul. 31, 2003, which is incorporated by reference. This application is also related to U.S. patent application Ser. No. 10/736,160, filed Dec. 15, 2003, which is incorporated herein by reference.

### BACKGROUND OF THE INVENTION

1. Field of the Invention

The present invention relates generally to content management. More particularly, embodiments of the present invention relate to systems, methods, and software for implementing a rule-based content management system that may be employed in a variety of computing environments.

2. Related Technology

Computer networks continue to proliferate due to declining costs, increasing performance of computer and networking equipment, and increasing demand for communication bandwidth. Client networks, including wide area networks (“WANs”) and local area networks (“LANs”), allow increased productivity and utilization of distributed computers or stations through the sharing of resources, the transfer of data, and the processing of data at the most efficient locations.

Moreover, as organizations and individuals have recognized the economic benefits of using client networks, network applications such as electronic mail, voice and data transfer, host access, and shared and distributed databases, are increasingly used as a means to increase user productivity. This increased demand, together with the growing number of distributed computing resources, has resulted in a rapid expansion of the number of installed networks.

As a result of the widespread use of computing devices and computer networks, various networks have experienced, and continue to experience, enormous growth in network content volume. As a result of such growth, a need has arisen for systems, devices and software configured to implement schemes that allow users to locate, access, share, back up, and otherwise manage, network content. A number of approaches have been devised in an attempt to fulfill the aforementioned needs. As discussed below however, such approaches have proven problematic for various reasons.

In general, many of the systems, devices and software developed to these ends rely to a large extent on manual operations performed by users and, moreover, are often complex and difficult to use and maintain. For example, in order to implement some or all of such functionality, information technology (“IT”) personnel may be required to set up and configure a wide variety of devices, networks, servers and personal computers (“PC”). Further, some of these processes must be repeated frequently, such as when it is desired to add a new user to the network. Additional complications are often introduced when it is desired to perform processes such as, for example, finding and/or uploading files, and updating virus protection and other software.

The problems and concerns associated with typical content management systems, devices and software are not limited to the foregoing however. Rather, as discussed below, many of the individual aspects of content management, such as file sharing, content backup and remote content access for example, implicate various problems not adequately addressed by currently available content management systems, devices and software.

With particular reference to file sharing, for example, some users have attempted to implement file-sharing and related functionality by using electronic mail, or ‘email,’ to transmit files to other users. However, sharing files in this way is problematic, because email software is generally not designed or intended for use in implementing file sharing schemes.

By way of example, for each content file or group of content files desired to be sent by email, the sender must specify in the email the name of each of the recipients to whom such content files will be sent. This approach to file sharing can be frustrating and time-consuming, particularly for users that frequently disseminate a variety of different content types to different groups of recipients. Moreover, attaching content files to an email can slow the operation of the email program and may, in some instances, result in corrupted or truncated content files.

Further, some content files are too large to be sent by email and so must be loaded on electronic media that is then physically transported to the intended recipient. Such manual processes are time-consuming, expensive, and unreliable, particularly where a large amount of content or a large number of files is desired to be transferred.

Yet other file-sharing schemes have been implemented in the form of servers and Internet-based storage sites. However, these types of systems and environments typically lack effective and reliable systems and software to search for and locate content. Such limited search capabilities compromise the ability of users to locate, access and share content.

A further problem with the use of servers and Internet-based storage sites as a vehicle for implementation of file sharing schemes is that both servers and Internet storage sites can be quite expensive to purchase, use and maintain. Moreover, the storage capabilities of servers and Internet storage sites are typically rather limited. Another concern relating particularly to Internet storage sites is that such sites often lack effective security measures so that content located at those sites may be vulnerable to hacking or other unauthorized access. Moreover, the basic model by which servers and Internet-based storage sites have been implemented involves users interacting directly with the servers and Internet-based sites, rather than with other users, which makes sharing data and collaboration between users difficult.

As suggested earlier, the proliferation of network content has given rise to a need for rapid, effective and reliable backup of such content. However, the various approaches typically employed to implement content backup, such as by burning files onto optical disks (“CD”) or copying files to high-capacity portable magnetic media, have proven largely ineffective and are labor-intensive.

One problem with the use of portable media for backup purposes is that such media is relatively limited in terms of its content capacity. Thus, large files and/or a large volume of content typically cannot be backed up in this way. Moreover, many networks lack systems, hardware and software necessary to implement a systematic approach to backing up content. For example, because the use of portable media for content backup is, at least in part, a manual process, backups are typically only performed on an ad hoc basis and may require significant user involvement. Thus, these types of arrangements are not well-suited for use in implementing automatic content backup and are not easily implemented by home or small-office users.

The use of portable media as a content backup mechanism is also problematic because such media are easily misplaced or lost. Thus, such media are unreliable and may make it difficult, if not impossible, to find and/or retrieve backed up content. Moreover, at least some types of portable media are subject to varying degrees of natural degradation with the passage of time, so that periodic transfer of the backed up content to other media is typically required.

Not only does the proliferation of content have implications with respect to content backup procedures and file sharing, but it is often the case that users, business travelers for example, desire to be able to effectively and reliably access such content from remote locations. Various types of hardware and software have been devised to this end, but have not proven particularly effective in implementing such remote content access functionality.

By way of example, virtual private networks (“VPN”) have been developed that essentially permit secure transmission of content over public communications networks, such as the Internet, thereby permitting VPN remote clients to access an office network or device, for example. While VPNs thus provide some useful functionality, the hardware and software necessary to implement the VPN is relatively expensive. In addition, VPNs generally provide access to an entire network, as opposed to providing access to specific content on a network.

Virtual private networks are often difficult to set up, configure and maintain, and are not designed for intermittent connections. This is of particular concern for individual users, home users, and small to medium sized businesses that typically lack the sophisticated IT resources and personnel that are available to large enterprises. For this reason, at least, VPNs often do not represent a viable avenue to implementation of remote content access.

In addition to VPNs, various types of software have been developed with a view toward facilitating remote access to computers. However, such software is typically limited to the use of PCs for implementing its functionality. Moreover, these software products can be difficult to install, configure and run, and operate by granting access to entire computers, not to specific content.

### BRIEF SUMMARY OF THE INVENTION

In general, embodiments of the present invention relate to systems, methods, and software for implementing a rule-based content management system in a variety of different computing environments.

In one exemplary embodiment of the invention, a content management system is provided that includes a database and associated policy engine that contains various rules pertaining to content management. Generally, such rules include various actions to be performed with respect to identified content, consistent with, for example, the metadata profile associated with that content. In this exemplary implementation, such actions are also performed in response to the occurrence of certain content events associated with the identified content.

In operation, the occurrence of a content event, such as the creation of a particular type of file, is detected. The content management system then identifies the content with which the content event is concerned, in this case, the newly created file. The content management system then implements various actions, such as storing copies of the newly created file on predetermined computing devices, with respect to the identified content. The action or actions thus implemented may be implicated by the particular content event that was detected and/or by the metadata profile of the identified content.

In this way, various events that occur with respect to content associated in some way with the operating environment serve to automatically trigger predefined content management actions. The rules applied to perform the predefined content management actions are flexible, and can be defined in terms of the identities of third parties who are granted permission to access the content. In the case of such identity-based rules, the identities can be people, applications and services, as opposed to computers used by the people, applications and services. Thus, content associated with the operating environment is effectively and efficiently managed substantially in real time so as to facilitate, among other things, file sharing, content backup and/or other desired content-related operations. These and other aspects of embodiments of the present invention will become more fully apparent from the following description and appended claims.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a schematic diagram that illustrates aspects of an exemplary content management system;

FIG. 2 is a block diagram illustrating aspects of an exemplary content management rule structure;

FIG. 3 is a schematic diagram that illustrates an exemplary data structure that includes a data field as well as file system metadata and content management metadata;

FIG. 4 is a schematic diagram that provides further details concerning a file history portion of exemplary file system metadata;

FIG. 5 is a schematic diagram that provides further details concerning a content management action portion of exemplary content management metadata;

FIG. 6 is a schematic diagram that illustrates various exemplary content events that may serve as catalysts for implementation of various actions by the content management system;

FIG. 7 is a schematic diagram that provides further details concerning the exemplary content events illustrated in FIG. 6 and other content events;

FIG. 8 is a flow diagram that illustrates aspects of an exemplary implementation of a content management process;

FIG. 9 is a flow diagram that illustrates aspects of another exemplary implementation of a content management process as such process relates to a metadata profile;

FIG. 10 is a schematic diagram that illustrates aspects of an exemplary client-website operating environment suitable for embodiments of the invention;

FIG. 11 is a schematic diagram that illustrates aspects of an exemplary computer network operating environment suitable for embodiments of the invention; and

FIG. 12 is a schematic diagram that illustrates aspects of an exemplary computing device operating environment suitable for embodiments of the invention.

### DETAILED DESCRIPTION OF EMBODIMENTS OF THE INVENTION

Reference will now be made to the drawings to describe various exemplary embodiments of the invention. It is to be understood that the drawings are diagrammatic and schematic representations of such exemplary embodiments, and are not limiting of the scope of the present invention in any way, nor are they necessarily drawn to scale.

Embodiments of the invention relate generally to systems, methods, and software for implementing a rule-based content management system in a variety of different computing environments. As described below, such implementation is exemplarily achieved by providing a database and associated policy engine that contains various rules pertaining to content management. Generally, such rules include various actions to be performed with respect to identified content, in response to the occurrence of certain content events associated with the identified content. Such functionality facilitates, among other things, implementation of a highly customized and systematic approach to content management in a wide variety of operating environments.

I. Exemplary Structural Implementations

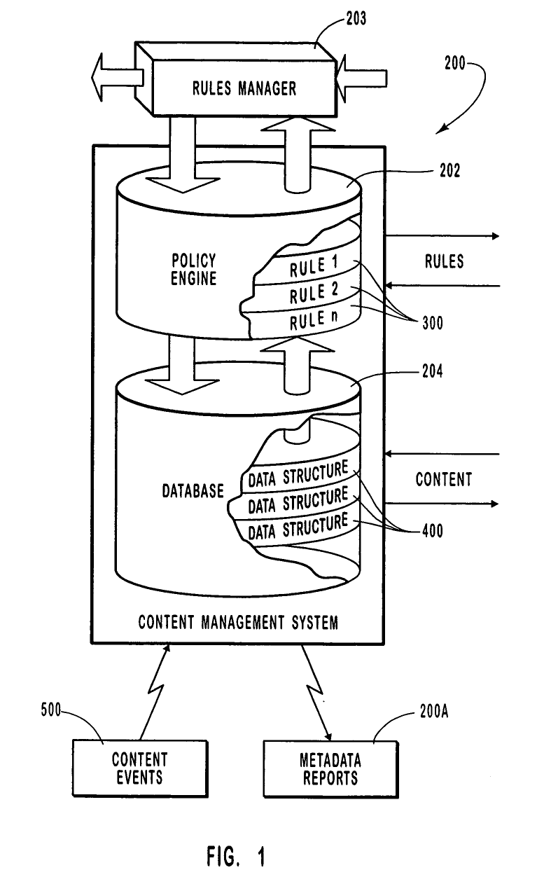

Directing attention now to FIG. 1, various details are provided concerning aspects of an exemplary embodiment of a content management system, denoted generally at 200. Note that, as used herein, ‘content’ includes, among other things, software, data, information, and any other electronic materials in conjunction with which it may be useful or desirable to employ embodiments of the invention.

In the exemplary illustrated embodiment, the content management system 200 comprises a policy engine 202 in communication with, or otherwise associated with, a corresponding database 204. While the policy engine 202 and database 204 are illustrated as being discrete elements of content management system 200, the policy engine 202 and database 204 may, in other embodiments, collectively comprise a single element. Accordingly, the embodiment presented in FIG. 1 is for illustrative purposes only and is not intended to limit the scope of the invention in any way.

Moreover, the functionality afforded by policy engine 202, as disclosed herein, may be implemented in various way and with various systems and devices. Similarly, database 204 may comprise any type of database and/or database structures suitable in facilitating implementation of the functionality disclosed herein. Consistent with the foregoing, any other systems, methods, devices, and/or software effective in implementing some or all of the functionality of content management system 200 may alternatively be employed, and the scope of the invention should not be construed to be limited to any particular implementation.

Among other things, the policy engine 202 includes, or is configured to access, various policies, or rules, 300 concerning management of content that is related to the environment wherein the content management system 200 is employed, or with which the content management system 200 is otherwise associated. As evidenced by the present disclosure, there is virtually no limit to the type, number and content of content management rules that can be defined. Likewise, the type and number of actions that can be implemented by the rules-based content management system disclosed herein is virtually unlimited.

In connection with the foregoing it should be noted that in some embodiments of the invention, some or all aspects of the rules 300 may, instead of being centrally deposited in the policy engine 202, be included or otherwise implemented within the metadata profiles, discussed below, associated with the various files or content with which the content management system 200 is concerned. The actions specified by the rules 300 in the applicable metadata profiles could then be implemented by the policy engine 202 with respect to the associated content. As suggested by the foregoing, the inclusion of the rules in a policy engine 202 is but one exemplary implementation and, more generally, the rules 300 may be constructed and implemented in any other way consistent with the functionality disclosed herein.

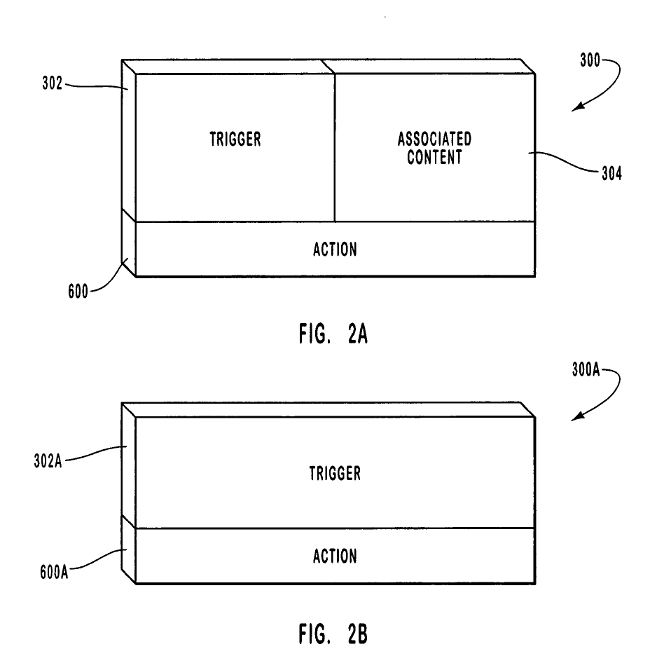

As suggested in the embodiment of the content management system 200 illustrated in FIG. 1, and as discussed below in connection with FIG. 2, the rules 300 are, in at least some instances, defined with reference to particular content, such as one or more data structures 400 contained in the database 204. Each of such database structures 400 typically comprises data, or a file, as well as various types of metadata concerning the data, or file, portion of the data structure. In some cases, the metadata associated with database structures 400 is used as a basis for generation and dissemination of various types of metadata reports 200A, discussed in further detail below. Moreover, the database 204 may be configured so that one or more of such data structures 400, or other content, can be imported to, and/or exported from, the database 204.

Generally, the rules 300 that guide the operation of the policy engine 202 with respect to the data structures 400 include provisions concerning actions to be taken with respect to particular content in the event of the occurrence, or non-occurrence, as applicable, of various content events 500 that, exemplarily, act as inputs to the content management system 200. As discussed in further detail below, such content events 500 generally refer to events that occur, or fail to occur, as applicable, that implicate in some way content contained in, or otherwise relating to, the operating environment wherein content management system 200 is employed, or with which content management system 200 is otherwise associated.

Thus, one aspect of the aforementioned relationships is that the policy engine 202, guided by the requirements specified in one more rules 300, is effective in implementing various desired content management operations with respect to one or more of the data structures 400 contained in database 204. Additionally, or alternatively, the policy engine 202 may, consistent with certain rules 300, implement various desired operations with respect to one or more data structures 400 located other than in database 204.

Moreover, rules 300 are not constrained for use solely with reference to specific content but may, more generally, be implemented at a variety of different levels. For example, rules 300 may be defined that are configured for implementation of various content management actions at a folder level, a computer level, a user level, a user group level, a computing environment level, or any other desired level in a given hierarchy.

In addition to their associated functionality, such rules 300 are configured to be manipulated in various ways. By way of example, and as suggested in FIG. 1, one or more of such rules 300 may be imported from another location by the policy engine 202. Likewise, one or more of the rules 300 resident at the policy engine 202 may be exported, such as to a policy engine associated with another system. Among other things, this functionality obviates the need for multiple recreations of previously developed rules.

The rules defined according to the invention can be identity-based, meaning that the content management operations can be performed with respect to specific identities. As used herein, an “identity” is defined as a person or another discrete entity, such as an application or service, that is capable of accessing or otherwise interacting with content. Thus, an identity-based rule defines a content management operation that is to be performed in connection with a selected person, application, service, or other identity. The identity-based rules can be used to share data with or grant access to specified third-party users, applications, or services, instead of granting access to specific remote computers.

In at least some cases, the policy engine 202 includes, or is otherwise associated with, a rules manager 203 that permits a user to define, or automatically generate in some instances, various rules 300 for use by policy engine 202 and/or by other systems and devices. The rules manager 203 may also be employed to, among other things, check for rules conflicts, import rules for use by the policy engine 202, and disseminate rules to various users and systems. The rules manager 203 may be implemented as an element of the content management system 200 or, alternatively, may comprise an element separate from, but configured for communication with, the content management system 200.

Another aspect of some embodiments of the invention is a conflict identification function that serves to identify and flag any conflicts between rules that, for example, pertain to the same content. As an example of such a conflict, one rule may specify that a particular file is to be backed up after the passage of a certain period of time, while another rule pertaining to the same file specifies that the file should be deleted after the passage of that period of time.

In some cases, the conflict identification function comprises a part of the rules manager 203 so that no new rule may be built or defined that conflicts with one or more existing rules. The conflict identification function may permit a user to delete one or more conflicting rules or, where such feature is included in the rules manager 203, may permit a user to craft a rule consistent with existing rules.

Further, rules may be defined with certain hierarchical references or aspects. By way of example, a system administrator may define certain rules for handling content on all machines in a particular operating environment. However, within the boundaries defined by such rules, a user may nonetheless define customized rules specific to that user, so long as such rules are consistent with the higher level rules specified by the system administrator.

Further details are now provided concerning exemplary embodiments of rules such as may be employed by policy engine 202 in the implementation of various actions concerning content associated with the environment in connection with which the content management system 200 is employed. Generally, such rules may be configured and/or employed in any fashion suitable to facilitate achievement of these ends.

Exemplarily, such rules 300 embody, or otherwise express, certain relationships between content with which the content management system 200 is concerned, and various other factors, such as, but not limited to, the occurrence or non-occurrence of various content events 500, and/or the metadata associated with such content. However, such content events and metadata are only examples of factors that may be considered in the definition of various rules 300, and any other factors or variables may additionally, or alternatively, be employed to that end as necessary to suit the requirements of a particular application.

II. Aspects of Exemplary Rule Configurations

With particular attention now to FIG. 2, one exemplary embodiment of a rule 300 is illustrated that defines relationships between and among a trigger 302, associated content 304 and one or more actions 600. The trigger 302 is exemplarily embodied, or represented by, a content event 500 whose occurrence, or non-occurrence, as applicable, serves as the trigger. However, the trigger 302, as well as trigger 302A discussed below, may alternatively be embodied or represented by various other states, events or circumstances, and/or by particular metadata corresponding to the associated content 304.

In general, the exemplary illustrated embodiment of rule 300 represents a particular relationship which may be expressed in the following form: “If content event ‘A’ occurs, then perform action ‘B’ with regard to associated content ‘C.’” This relationship is exemplary only however, and various other relationships may likewise be defined. By way of example, a rule may refer to other rules. Such a reference may be expressed, for example, as follows: “If rule ‘D’ is implemented with respect to content ‘E,’ then also perform the actions specified in rule ‘F’ with respect to content ‘E.’ Thus, in this exemplary case, the trigger 302 comprises the implementation of “rule D.”

As suggested by the foregoing, any number of different rules, rule types, rule combinations, rule hierarchies, rule cross-references, and other rules and relationships, can be defined that serve to guide the operation of the policy engine 202 with respect to content. As another example, yet other rules 300 may be defined whose trigger 302 comprises, either in whole or in part, metadata concerning particular content. One such exemplary rule takes the form: “Implement action ‘F’ every ninety days with respect to all files having the extension ‘jpeg’.” Thus, the foregoing, and other examples disclosed herein, are not intended, nor should they be construed, to limit the scope of the invention in any way.

It was noted above that the exemplary rule 300 illustrated in FIG. 2 refers to particular content with respect to which various actions are to be taken, but that any of a variety of rules, rule types, combinations, hierarchies, cross-references, and other rules and relationships may be defined as necessary to suit the requirements of a particular application. Consistent with the foregoing, exemplary rules may be defined and implemented that are not necessarily associated with particular content, but rather specify global actions that are to be taken in response to a specified trigger, or triggers.

With the foregoing in mind, reference is now made to the exemplary embodiment of global rule 300A illustrated in FIG. 2. As indicated there, global rule 300A defines relationships between a trigger 302A and one or more actions 600A. No particular content needs to be specified in connection with global rule 300A as such a rule type, by definition, applies to all content. As in the case of trigger 302 of rule 300, trigger 302A may be embodied or represented by content events, as well as by various other states, events or circumstances, and/or by the presence of particular metadata corresponding to the associated content 304.

By way of example, in the event that trigger 302A comprises a content event such as detection of a virus in the computing environment, action 600A may specify appropriate corresponding action. This exemplary relation may be expressed as: “If a virus is detected in the computing environment, then scrub all content files and backup the scrubbed content files to drive G.” In this way, global action can be implemented in correspondence with certain trigger events. This functionality precludes the need for individual action on the part of each user or device associated with the computing environment. Moreover, such functionality facilitates continuity and uniformity in the action, or actions, taken, and also contributes to orderly and timely implementation of such action.

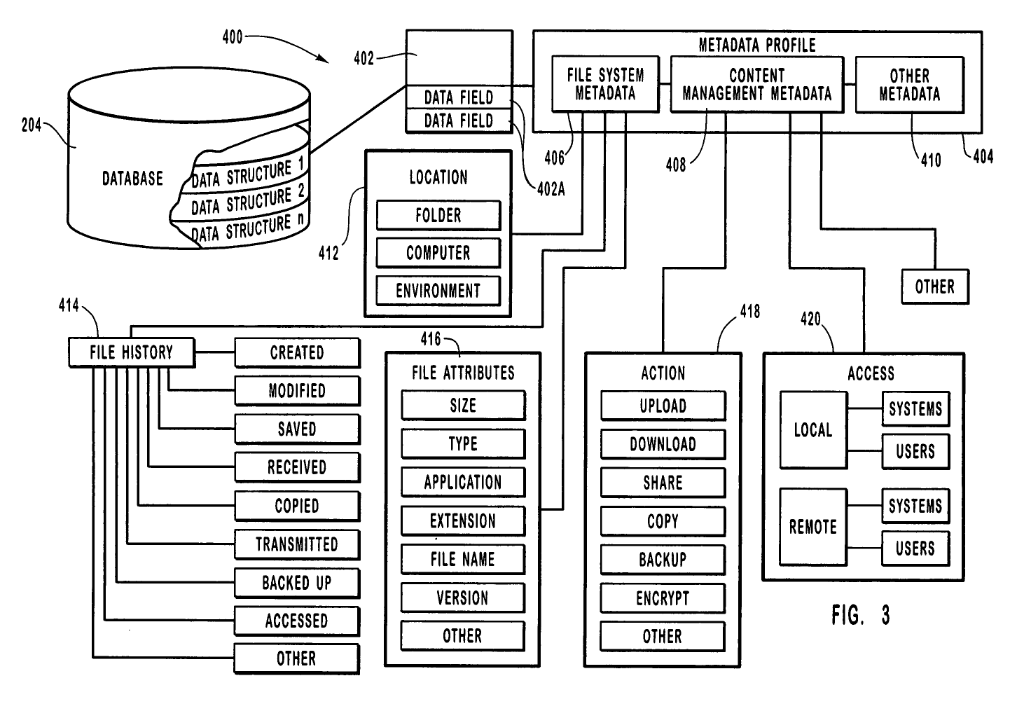

Yet other rules (not shown) may be defined so that no specific content is specified by the rule and so that certain actions may be implemented with reference to the metadata of various content, instead of with reference to content events. Such rules are, exemplarily, not limited to a single file 402, nor apply globally to all content but, instead, apply to an ad hoc group of content implicitly defined by the terms of the rule. One example of such a rule is considered in further detail below in connection with the discussion of FIG. 3.

III. Content Metadata

Directing attention now to FIG. 3, further details are provided concerning an exemplary data structure 400 in conjunction with which embodiments of the invention may be employed. In general, the illustrated exemplary embodiment of the data structure 400 includes a file 402 that comprises one or more data fields 402A. Generally, each file 402 has associated therewith a corresponding metadata profile 404 that includes or refers to various types of information concerning the file 402.

In one exemplary case, the metadata profile 404 comprises file system metadata 406, content management system metadata 408, and/or any other metadata 410 suitable for use in facilitating implementation of some or all aspects of functionality disclosed herein. Note that, as used herein “metadata” refers to information, data, and/or other materials that relate in some way to the file 402. Accordingly, the exemplary metadata illustrated in FIG. 3 should not be construed to limit the scope of the invention in any way.

As suggested above, the metadata profile 404 may comprise in any of a variety of different types and combinations of metadata concerning the data contained in data fields 402. Exemplarily, the metadata profile 404 includes various types of file system metadata 406 that concern various aspects of the file 402, such as, but not limited to, the location, file history and various attributes of file 402.

In the illustrated embodiment, the location metadata 412 of file system metadata 406 includes, among other things, information concerning the folder, computer and/or environment wherein file 402 is located. Such location metadata 412 may also specify information concerning the location of any duplicates of file 402.

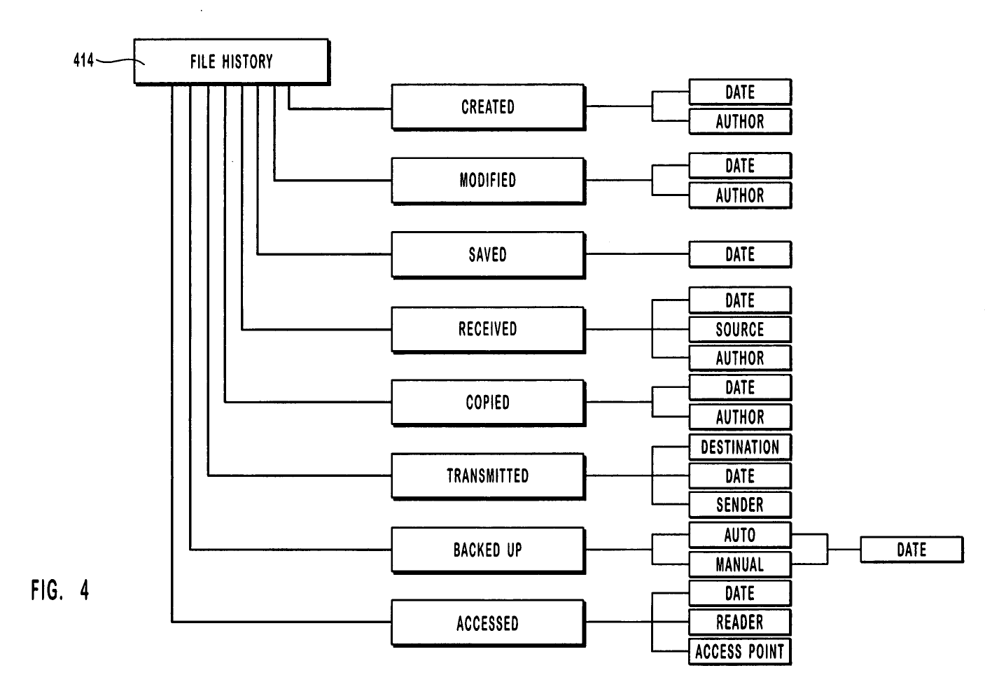

In addition to such location metadata 412, the exemplary file system metadata 406 of metadata profile 404 also comprises file history metadata 414. Such file history metadata 414 may include, among other things, information concerning the creation, modification, saving, receipt, copying, transmission, backup and access information concerning file 402, as well as various other information pertaining to events in the history of file 402. As discussed in further detail below in connection with FIG. 4, each of the foregoing exemplary aspects of the file history metadata 414 may likewise have associated metadata.

The exemplary embodiment of metadata profile 404 further includes, in addition to location metadata 412 and file history metadata 414, various file attribute metadata 416. In general, the file attribute metadata 416 comprises information or data relating to certain specific aspects of the particular file 402 with which the file attribute metadata 416 is associated. By way of example, and as suggested in FIG. 3, such file attribute metadata 416 may include information concerning, but not limited to, the size, type, application, extension, file name and version of file 402. Moreover, file attribute metadata 416 may, more generally, comprise data concerning any other attribute of file 402.

Thus, an aspect of embodiments of the invention is that comprehensive file system metadata may be created and preserved concerning each file 402 stored in database 204. As disclosed elsewhere herein, such file system metadata 406 may be used for various purposes including, but not limited to, the generation and transmission of various metadata reports which allow a user, administrator or other personnel to readily obtain comprehensive information concerning activity relating to file 402 and/or similar files, as well as information specific to various attributes of file 402. Moreover, such file system metadata 406 may additionally, or alternatively, be employed in the definition of various rules, and thereby facilitate implementation of various content management system actions 600 concerning the content with which the file system metadata 406 are associated.

With renewed attention now to FIG. 3, details are provided concerning exemplary content management metadata 408 as may be defined and employed in conjunction with the file 402. It should be noted that the illustrated content management metadata 408 are exemplary only and various other types of content management metadata may additionally or alternatively be employed, be consistent with the requirements of a particular application.

In the illustrated embodiment, the content management metadata 408 include, among other things, action metadata 418 which exemplarily comprises information concerning processes such as the upload, download, sharing, copying, backup and/or encryption of file 402. As suggested by the foregoing examples, the action metadata 418 generally indicate the action or actions that must, or will be, taken by the content management system 200, or otherwise implemented, with respect to file 402 consistent with the requirements of one or more applicable rules 300. In one implementation, the action metadata 418 is defined and loaded in the metadata profile 404 upon creation of the rule(s) 300 which correspond or refer to file 402. As another example, the action metadata 418 may be defined and loaded in the metadata profile 404 by a user, file author, administrator, or other personnel.

Thus, by examination of the action metadata 418 associated with file 402, a determination can readily be made as to the action or actions that will be implemented with respect to file 402 in the event of fulfillment of any associated triggers. This functionality permits a user or other personnel to modify, as/if required, the rules associated with file 402 to ensure that the desired actions are implemented with respect to file 402.

Moreover, use of the action metadata 418 need not be limited solely to the informational role described above. In particular, the content management system 200 may, upon consulting an applicable rule, determine that all files 402 whose action metadata 418 indicates, for example, sharing file 402 with users 1 and 2, are to be shared with such users upon occurrence of a content event 500 specified by the rule. One, more general, expression of such an exemplary rule reads as follows: “If content event ‘P’ occurs, implement action ‘Y’ respecting all content whose action metadata 418 references action ‘Y’.” As described earlier, such a rule is neither global, nor specific, at least by definition, with respect to particular content.

In the aforementioned case, at least, the action metadata 418 associated with file 402 thus aids in the definition of an ad hoc group of content regarding which certain actions are to be taken as specified in the applicable rule or rules. More particularly, the applicable content in such cases is determined ‘on the fly’ by defining such content to include all content whose metadata profile 404 includes a predetermined reference at the time a particular content event, or other condition, occurs or is present.

With continuing reference now to FIG. 3, the illustrated content management metadata 408 further comprises access metadata 420. As suggested there, such access metadata 420 relates generally to the circumstances in which file 412 may be accessed such as, but not limited to, whether such access may be made locally and/or remotely, the identity of the system or systems through which such access may be obtained, and the users authorized for such access. Of course, the access metadata 420 and more generally the other content management metadata 408, may be configured and defined as necessary to suit the requirements of a particular application and/or operating environment. Accordingly, the implementations disclosed herein are exemplary only and are not intended to limit the scope of the invention in any way.

As the foregoing discussion of FIG. 3 suggests, an aspect of embodiments of the invention is that various content management actions, respecting one or more files 402, can be implemented automatically, in response to the presence or occurrence of certain conditions, states, or other circumstances or information, based upon certain rules whose elements and relationships may be either predefined or defined contemporaneously with the presence or occurrence of such conditions, states, or other circumstances or information. Another exemplary aspect of embodiments of the invention is that such content management actions may be implemented substantially in real time, or on some other temporal basis. The foregoing, and other, functionality associated with embodiments of the invention, contributes to material improvements in the consistency and reliability with which a wide variety of content may be processed, managed, and made accessible in a particular computing environment.

Directing attention now to FIG. 4, further information is provided concerning various aspects of the exemplary file history metadata 414 included in the file system metadata 406 illustrated in FIG. 3. In particular, and as suggested in FIG. 4, various other information and metadata may be associated with, or comprise, a portion of file history metadata 414. By way of example, information concerning the creation of file 402 with which file history 414 is concerned, may further include, among other things, the date of creation of the file 402, as well as the author of file 402. Similar information may likewise be provided for file history metadata 414 concerning when file 402 was modified and/or copied. Also, information such as the date that file 402 was most recently saved may comprise a portion of file history metadata 414.

In similar fashion, information such as, but not limited to, the date file 402 was received at a particular location, as well as the initial source of file 402 and the author of the received file 402 may likewise comprise a portion of file history metadata 414. In connection with the foregoing, information such as, but not limited to, the destination of file 402, in the event file 402 has been transmitted, as well as the date of transmission and the sender of file 402 may comprise a portion of file history metadata 414.

Archive or backup information concerning file 402 may likewise be provided. For example, the exemplary illustrated embodiment of file history metadata 414 includes information concerning aspects such as the date of the most recent backup of file 402, as well as information concerning whether or not such backup was performed automatically or manually by the content management system 200.

Finally, the exemplary file history metadata 414 comprises information concerning circumstances surrounding the most recent access that was made of file 402. By way of example, such circumstances may include the date of such access, the user or users who accessed file 402, as well as the location or access point from which such access was achieved. As noted elsewhere herein, the information contained in or otherwise embodied by file history metadata 414 and illustrated in FIGS. 3 and 4, is exemplary only and, more generally, any other information concerning the history of file 402 may additionally and/or alternatively be included.

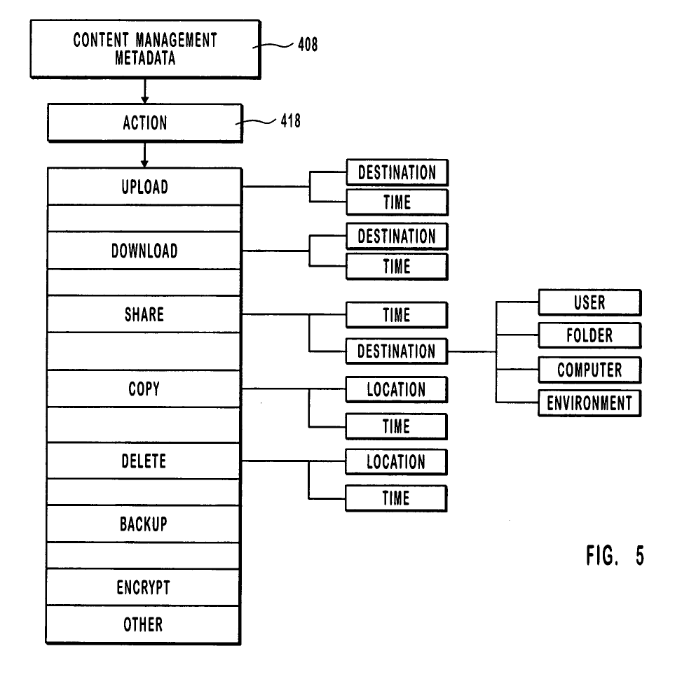

As noted earlier, the content management metadata 408 exemplarily comprises information or metadata concerning various content management actions that must, or will be, taken respecting file 402, upon satisfaction of, for example, certain conditions specified in one or more rules 300. With reference now to FIG. 5, such action metadata 418 may include, in addition to information concerning such content management actions, further specific information relating to one or more particular content management actions.

By way of example, the upload and download actions specified in the exemplary implementation or representation of action metadata 418 may each additionally include information concerning, respectively, the destination of the upload and download, as well as the time at which such upload and/or download should occur. As another example, the share action defined or included in action metadata 418 may further include, or be associated with, information concerning the time at which the share action is to be implemented.

In connection with the foregoing, the share action may also have associated information concerning the destination of the shared file, wherein the destination may be defined, for example, as one or more particular users, folders, computers and/or computing environments. In similar fashion, the copy action may have associated information concerning the location to which file 402 is to be copied, as well as the time at which the copying action is to be implemented. Similar information may also be included or associated with the backup action of the action metadata 418.

As further suggested in FIG. 5, various other actions such as deletion and encryption of file 402 may be specified in the action metadata 418. As an example, the delete action may be referenced in a rule that provides that if file 402 has remained unmodified for a predetermined time period, file 402 will be deleted.

With respect to the encryption example, the encrypt action specified in the action metadata 418 may specify information such as, but not limited to, the time and place of encryption, as well as the type of encryption to be performed with respect to file 402. As further suggested in FIG. 5, any other action may be specified or included in action metadata 418 as necessary to suit the requirements of a particular application and/or operating environment.

As evidenced by the discussion herein of the metadata profile 404 and associated metadata, such metadata can be readily selected and defined in a wide variety of ways. Such flexibility permits, among other things, a highly customized approach to content management and generation of content information.

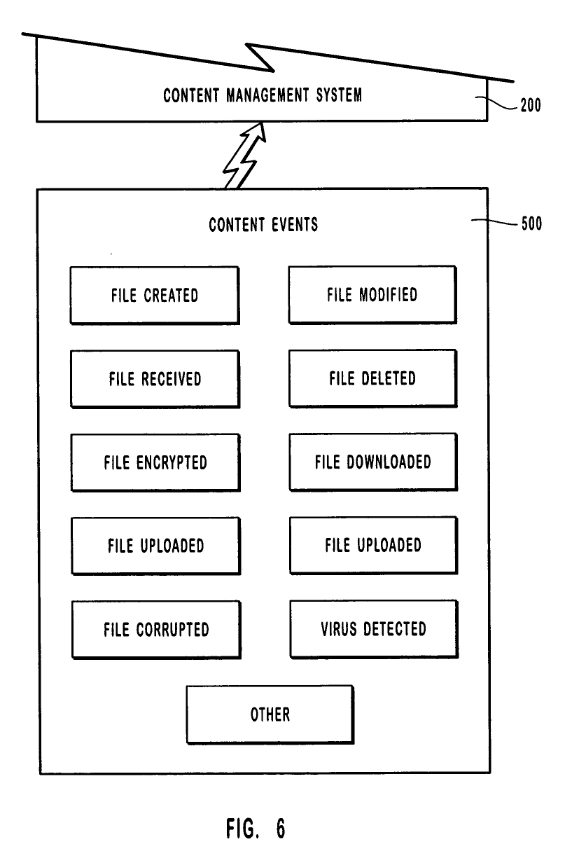

It was noted earlier in the discussion concerning the definition of various rules 300 that, in at least some exemplary embodiments of the invention, the occurrence of one or more content events 500 serves as the trigger for implementation of an action or actions specified in one or more rules 300. As suggested in FIG. 6, discussed below, such content events 500 may comprise events that relate specifically to a single file 402, to all files 402, or to some subset of files 402 in a particular system.

IV. Aspects of Exemplary Content Events

With more specific reference now to FIG. 6, some exemplary content events such as may be defined or otherwise associated with one or more files 402 include, but are not limited to, creation of the file, receipt of the file from a sender, encryption of the file, uploading of the file, modification of the file, deletion of the file, downloading of the file, and conversion of the file to a particular format, as well as a detected corruption of the file.

Yet other exemplary content events include, but are not limited to, a user logon to a device associated with the operating environment, a user logoff from a device associated with the operating environment, establishment of communication between a remote device and the operating environment, and establishment of communication between a local device and the operating environment, such as may occur when a new device is brought online in the operating environment.

In the aforementioned user logon case, for example, the content management system may be programmed to synchronize all content, or specified content, on the machine of the user immediately subsequent to logon so that the user is assured that all content on that machine is the most current. Alternatively, the content management system may be programmed to synchronize all content, or specified content, on a machine after a user has logged off of that machine. As yet another example, the content management system may be programmed to synchronize all content, or specified content, on a machine substantially in real time, without reference to whether or not a user is logged on to that machine.

It should be noted that the content events disclosed herein are exemplary only and by no means constitute an exhaustive enumeration of content events in conjunction with which embodiments of the invention may be employed. Accordingly, such exemplary content events should not be construed, either individually or collectively, to define or limit the scope of the invention.

At least some of such content events may relate to more than a single file 402. One example of such content event is the detection of a virus in a system or device with which the content management system 200 is associated. In this exemplary case, such virus detection may be used as a trigger to cause the scrubbing and backup of all files in the system, or of all files of a predetermined type.

Thus, one aspect of embodiments of the invention is that certain desired content management actions can be implemented globally, as well as being implemented with respect to a particular file or group of files. More generally, content management actions can be readily defined, selected and combined in a wide variety of ways. Such flexibility permits, among other things, a highly customized approach to content management.

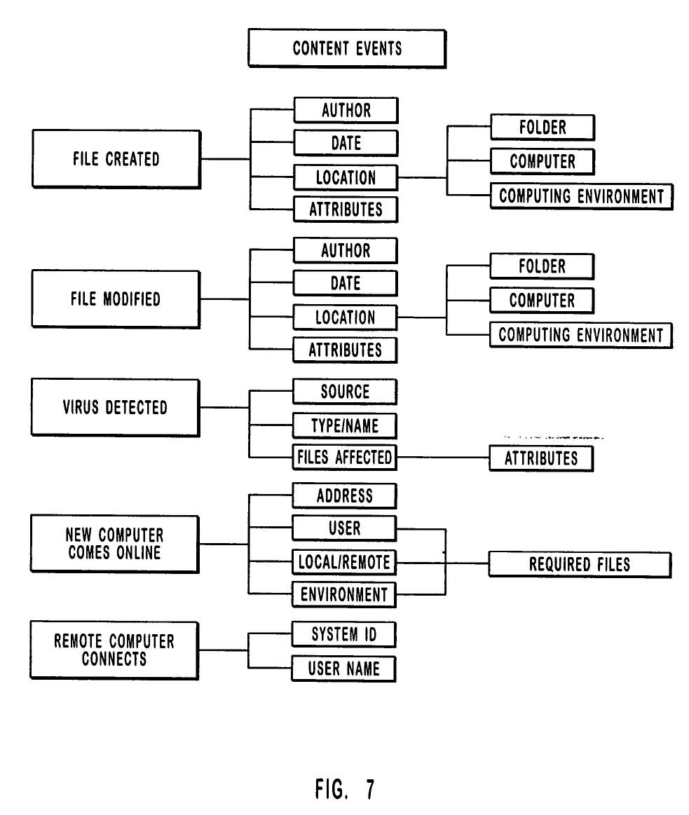

As suggested earlier, one or more of the content events 500 specified or otherwise associated with one or more rules 300 may, similar to the metadata contained in the metadata profile 404, further include, or otherwise have associated therewith, further specific information concerning a particular content event. Directing attention now to FIG. 7, details are provided concerning such further specific information relating to content events 500 that may be employed in connection with the implementation of aspects of the content management system 200 functionality.

As indicated in FIG. 7, the file creation content event, for example, may be further refined and/or defined by providing or associating information concerning such file creation. By way of example, such information relating to the file creation content event may include information such as the author, date of creation and various attributes of the created file. Such information may additionally comprise information concerning the location, such as the computer and/or computing environment, at which the file was created. Similar information may be provided in connection with the file modification content event, as suggested in FIG. 7.

It was noted earlier that at least some content events may implicate not simply a single file, but instead may implicate a predetermined group of files, or all files, associated with a particular operating environment. Consistent with the foregoing, and as illustrated in FIG. 7, the virus detection content event, for example, may include or have associated therewith information such as the source of the virus, the type and/or name of the virus, as well as a list of files affected by, or vulnerable to, the virus and the attributes of files. Thus, the detection of the occurrence of content events, such as virus detection, that implicate multiple files, or all files, enables content management system 200 to take global actions as/if required.

As another example, multiple files or content may be implicated by such actions as may be necessary when a new computer is brought online in the operating environment with which the content management system 200 is concerned. With reference to FIG. 7, certain aspects concerning a content event wherein a new computer comes online may relate to, among other things, the address of the new computer, as well as information such as the user or users associated with such computer, whether such computer is located locally or remotely with respect to a particular environment, and information concerning the environment wherein the new computer is to be situated.

Some, or all, of the foregoing information may then be used to facilitate definition of one or more rules 300 that specify, for example, that when a new computer comes online, certain files resident on database 204 should be uploaded to the new computer. For example, when a computer aided design (“CAD”) machine comes online, the rule 300 would specify that copies of all graphics files in the operating environment be loaded onto the CAD machine. Such rules 300 may also specify, among other things, the manner and structure of the organization of such content on the new computer.

One aspect of such functionality is that new computers can be quickly and automatically populated with a predetermined body of content, consistent with the aforementioned rules 300 concerning that new computer and/or such files. In this way, the content associated with such new computer is readily synchronized with the content of similar computers already connected to the operating environment. Thus, any user operating the newly connected computer would be assured that content resident on that computer reflects the most up to date content currently available in the operating environment. Moreover, such user would not be compelled to search for, and/or download, the content relevant to that computer. Another aspect of such functionality is that in the event a computer associated with the operating environment were to suffer a catastrophic content loss, the content associated with that computer could be quickly, easily and accurately restored.

Yet another exemplary content event, and associated aspects thereof, illustrated in FIG. 7, relates to the establishment of communication between a remote computer and the environment which content management system 200 is associated. In the case of this exemplary content event, information such as the system identification and/or user name associated with a remote computer are likewise included or otherwise associated with the remote computer connection content event.

One aspect of such an arrangement is that various rules 300 may be defined that provide for automatic synchronization of content present on the remote computer every time, or on some other schedule, that the remote computer connects with a particular operating environment or network with which the content management system 200 is employed. In this way, the user of the remote computer is assured, among other things, after such connection is implemented, that the content associated with that computer reflects the latest content available within the associated computing environment. Accordingly, the remote user need not engage in time consuming and frustrating reviews of the content of the remote computer to determine whether or not such remote computer includes the most current information.

A further example of a content event (not shown) concerns changes made to a metadata profile of a particular file 402. In particular, content management system 200 may be programmed to periodically examine each metadata profile so that in the event of a change to a metadata profile subsequent to a prior examination, the content management system 200 will perform any further actions necessitated by such a change to the metadata profile. One aspect of such functionality is that content can be updated and synchronized or other operations performed automatically in response to the desires of the user, as such may be expressed by changes to one or more metadata profiles.

V. Aspects of Exemplary Content Management Process Implementations

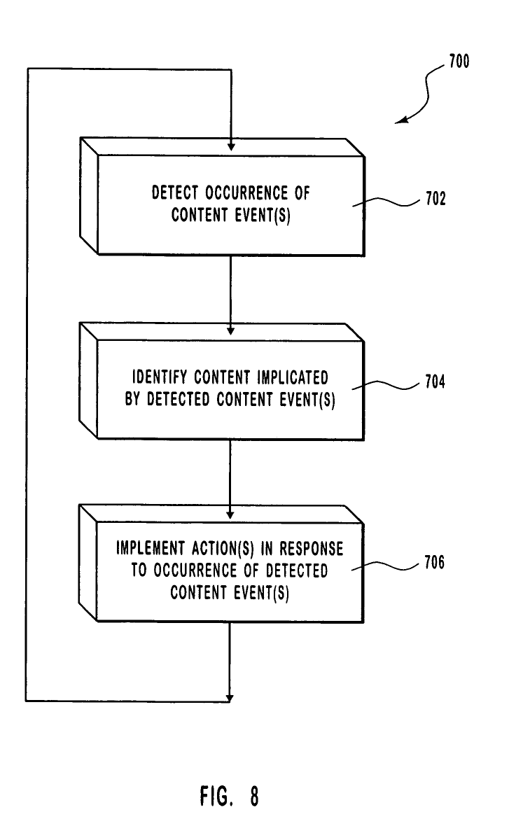

Directing attention now to FIG. 8, various aspects of a process for content management, designated generally at 700, are indicated. As suggested earlier, the content management process 700 generally comprises three different aspects. In particular, state 702 of process 700 is initially entered wherein the occurrence of one or more content events is detected, or otherwise made known to, by the content management system 200. As suggested earlier, such content event may relate to a particular file, a group of files, or all files in a particular operating environment.

At such time as the occurrence of the content event has been detected, the process 700 moves to state 704. In general, state 704 is concerned with the identification of any and all content that is implicated, such as by way of rules 300, by the detected content event or content events. In one embodiment of the invention, such content can be identified by an examination all of the rules 300 that refer to the detected content event. Once that set of rules has been identified, the content associated with each such rule can then be readily determined by cross-referencing the content event associated with a particular rule 300 with the content associated with that particular rule 300. In the case where the rules 300 are included as part of the metadata profiles 404, identification of the content implicated by a detected content event can be made by searching all of the metadata profiles and identifying those profiles, and corresponding content, that reference the detected content event.

At such time as the content implicated by the detected content event has been identified, the process 700 then moves to state 706. In state 706, the various actions specified by the applicable rules 300 are then implemented by the policy engine with respect to the identified content.

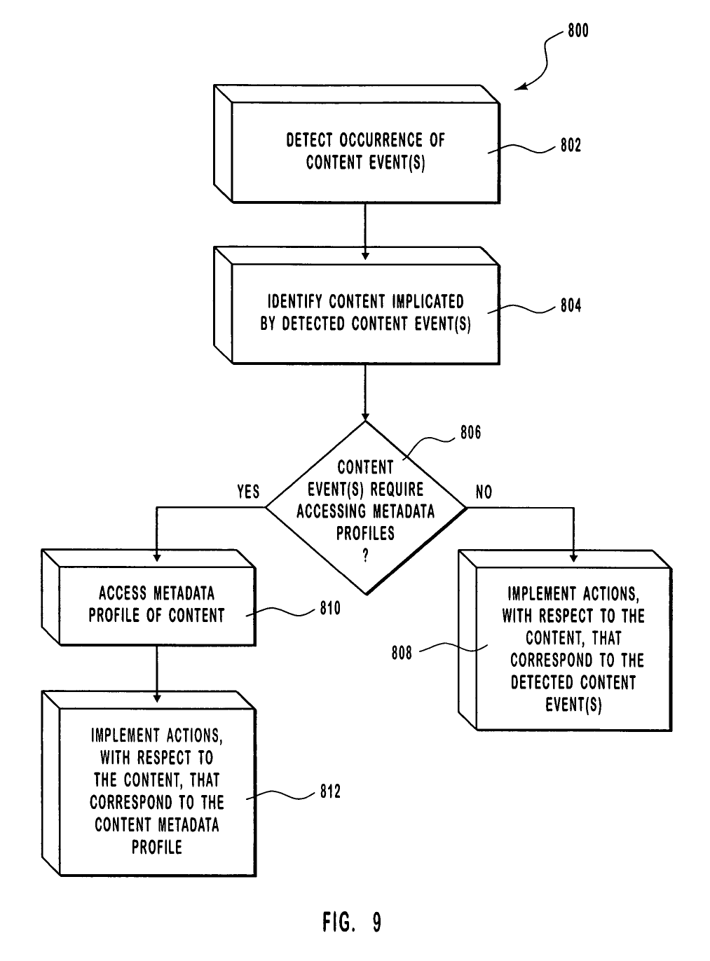

Directing attention now to FIG. 9, details are provided concerning another exemplary embodiment of a content management process, denoted generally at 800. Generally, state 802 is similar to state 702 of process 700 wherein the occurrence of a content event is detected. Upon detection of the occurrence of a content event, process 800 moves to state 804 where the content implicated by occurrence of the content is identified. Upon identification of such content, the process 800 then advances to decision point 806 where the inquiry is made as to whether or not the detected content event requires accessing of one or more individual metadata profiles. In the event that no such access is necessitated, the process 800 advances to state 808 wherein, consistent with the applicable rules 300, various actions are implemented with respect to the identified content that correspond to the detected content event.

A sequence of events such as that just described may occur, for example, where a new file is created. In this exemplary situation, the fact that the file is newly created means that, with respect to some content management actions at least, no reference to the metadata profile of the file is required. For example, one applicable rule 300 may provide that any newly created file is to be automatically backed up on a predetermined drive. Thus, this action can be implemented without reference to the metadata profile of the newly created file.

In yet in other cases however, it may be determined at decision point 806 that the detected content event does implicate accessing of one or more metadata profiles. In this event, the process 800 advances to state 810 wherein the metadata profile of the identified content is accessed. Finally, the process 800 advances to state 812 where various actions, specified by one or more rules 300 are implemented concerning the identified content, with reference to the content metadata profile.

The aforementioned situation may arise where a rule is defined that provides that any newly created file whose metadata profile indicates, for example, that such file has a jpeg extension, should be backed up as well as distributed to various predetermined users. In this implementation, the rule 300 does not refer to any specific associated content, but rather causes the policy engine to take action with respect to content identified as newly created and whose metadata profile contains certain metadata.

VI. Exemplary Operating Environments

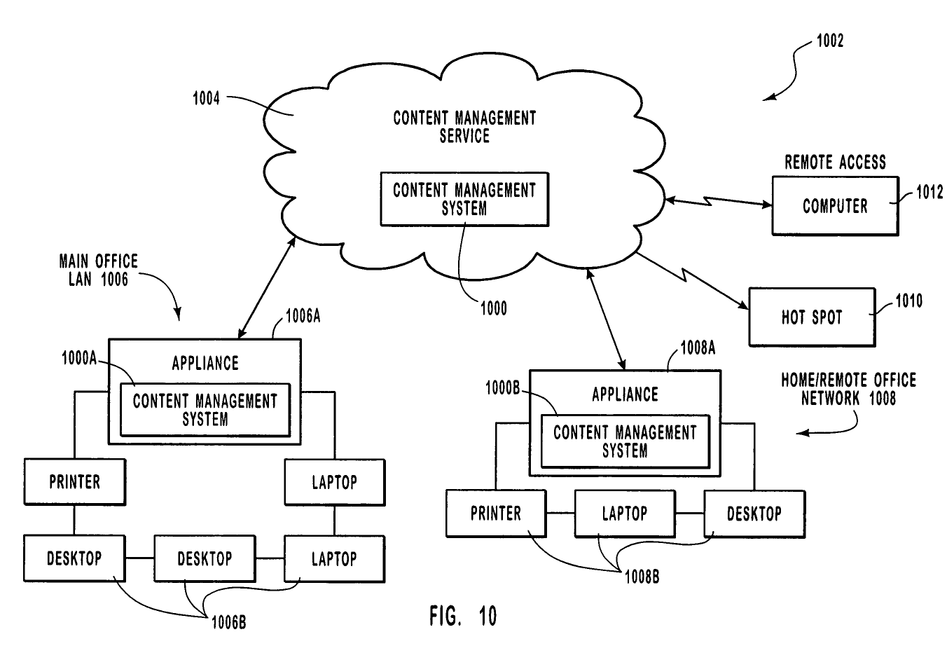

Directing attention now to FIG. 10, details are provided concerning one exemplary implementation of a content management system, denoted generally at 1000. In the illustrated embodiment, the content management system 1000 is implemented in a client-website computing environment 1002. In general, the client-website computing environment 1002 comprises a content management service website 1004 configured for communication with a variety of clients such as a main office LAN 1006, a home/remote office network 1008, a ‘hotspot’ 1010 and a computer 1012 configured for remote access.

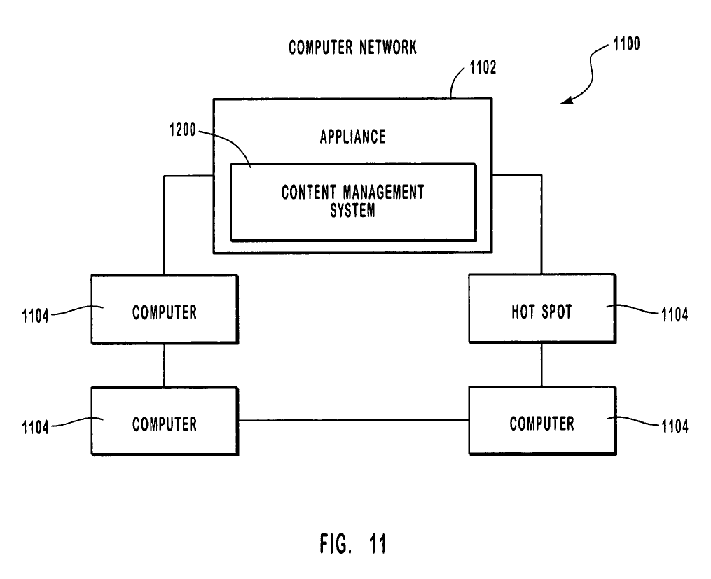

Both the main office LAN 1006 and home/remote office network 1008 each include corresponding appliances 1006A and 1008A, respectively, that are configured to include, or otherwise implement, functionality concerning the content management system 1000. Generally, such appliances may comprise any system or device capable of implementing the functionality disclosed herein, such as appliances 1006A and 1008A of FIG. 10 and appliance 1102 of FIG. 11. In this exemplary configuration, appliances 1006A and 1008A are generally configured to implement such functionality with respect to various devices in their respective local operating environments such as, respectively, computing devices 1006B and 1008B. The versions of the content management system employed in this regard with respect to the main office LAN 1006 and the home/remote office network 1008 are denoted, respectively, at 1000A and 1000B.

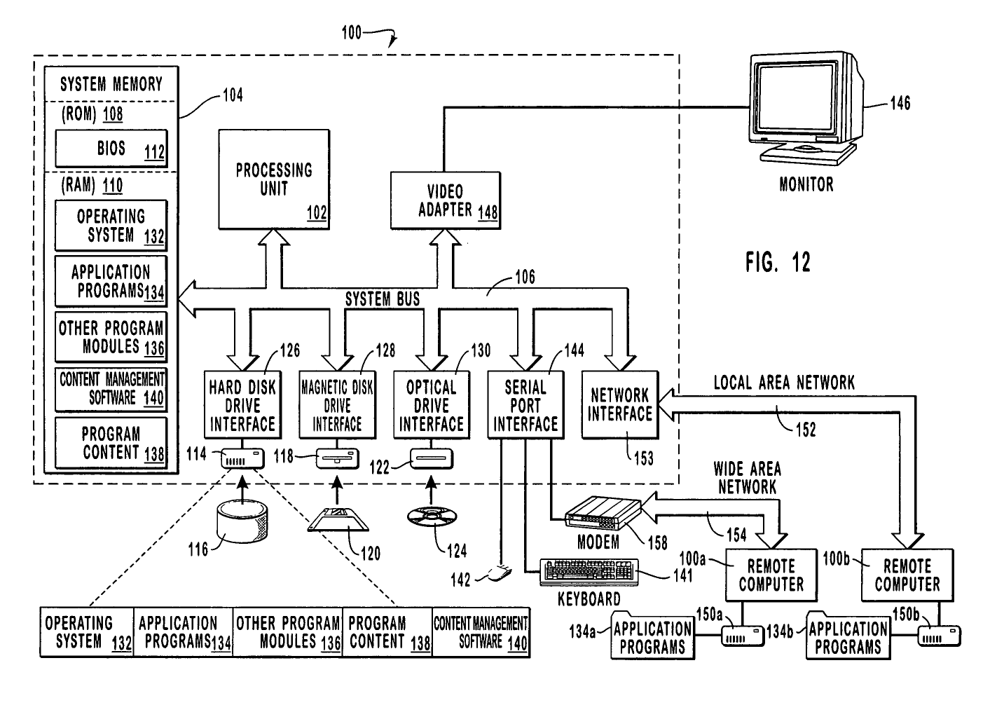

As noted above, an additional exemplary client of the content management service 1000 comprises a hotspot 1010. In general, the hotspot 1010 comprises various devices through which content can be viewed or accessed, such as in a read-only mode. The hotspot 1010 may include locally stored content and/or may simply operate as a ‘window’ on content stored at the content management service website 1004. Yet another exemplary client of the content management service 1000 comprises a computer 1012 that is configured for remote access to the content management service 1000, either by way of a hardwire or wireless connection. Note in this regard that further details regarding exemplary computing devices and environments in conjunction with which embodiments of the content management system may be employed are provided below in connection with FIG. 12.

As various operational aspects of exemplary embodiments of a content management system have been disclosed elsewhere herein, the following discussion of the functionality associated with the specific arrangement illustrated in FIG. 10 will focus primarily on the aspect of content management system 1000 operations specific to such an exemplary arrangement.

As suggested in FIG. 10, various aspects of content management may be distributed among the content management service website 1004 and one or more of the associated clients. By way of example, the content management system 1000A may be configured to receive data from the content management system 1000 and synchronize the received data on the various devices that comprise the main office LAN 1006. The same arrangement may likewise be implemented with respect to the content management system 1000B of home/remote office network 1008.

Thus, each of the clients is configured to implement, by way of their respective appliances, certain content management functionalities concerning only their associated devices. Accordingly, the overall synchronization of content among all of the clients is implemented by way of the content management system 1000. In this way, content changes or other events occurring within, for example, main office LAN 1006 can be reflected, by operation of the content management system 1000, at other clients such as computer 1012 hotspot 1010 and/or home/remote office network 1008.

The content management system 1000 implemented within the content management service 1004 may additionally include various identity-based rules concerning operations to be performed with respect to data received from one or more of the clients. Identity-based rules represent a sharing or collaboration mechanism by which permission to access or share files or other content is granted based on the identity of the users as opposed to the identity of the computers being used by the users. As used herein, an “identity” is defined as a person or another discrete entity, such as an application or service, that is capable of accessing or otherwise interacting with content. The following discussion is presented primarily in the context of a user who is an example of an identity, although the principles disclosed herein are also applicable to other identities, such as applications or services.

The identity-based rules can be implemented by establishing an identity namespace, in which each identity is given a unique identifier. The namespace can use, for example, e-mail addresses or other identifiers that have been used for other purposes and are readily available in a network. Thus, in order to be recognized as an identity to which identity-based rules can be applied, users or other identities are registered by being associated with e-mail addresses or other unique identifiers. Registering can be performed, for instance, when a new network appliance with one or more users is installed or when an existing user refers a third-party user into the system. In general, any identity that is to gain access to content through content management system 1000 is registered and is associated with a unique identifier in the identity namespace.

The identity-based rules define content operations that can be performed with respect to specified identities. A user who operates a network appliance 1006A or 1008A can specify which identities are to be granted certain types of access to content associated with the network appliance. Thus, the user can define identity-based rules that are to be applied to specific content. Although the invention extends to substantially any mechanism for selecting or composing the identity-based rules and applying them to specified content, there are various techniques for simplifying this process. For example, the process of selecting or composing identity-based rules can be facilitated by maintaining an third-party identity list for a user.

The third-party identity list can be maintained or presented in a manner similar to conventional contacts lists in e-mail or calendaring applications or buddy lists in instant messaging applications. Unlike contacts lists and buddy lists, however, the third-party identity lists of the invention can include applications and services in addition to including people. The user interface presented by the network appliance to the user during the identity-based rule selection process can include a set of available operations that can be applied to content. For instance, when a user has created or otherwise wishes to manipulate the content of a file associated with the network appliance, the user selects the file (e.g., by right-clicking on an icon associated with the file) to view a drop-down list with a set of content operations (e.g., share, forward, hide, etc.). The user can select the content operation and then select one or more identities to be applied to the content.

As noted above, the identities can include people, applications, and services. Thus, the identity-based rules can be used to grant people (i.e., human users) access to content. In addition, the identity-based rules can be used to share content with remote services or applications. While the types of applications and services that can be identities are essentially unlimited, one example of a service is a website on which photographs or other content can be posted and shared with authorized remote users. It is also noted that the applications and services, such as those described above, can be commercial websites or other services operated by third-party entities that are independent from the users or the manufacturers of the network appliances disclosed herein.

According to this example, the user might decide to define an identity-based rule under which the content management system 1000 forwards a copy of photographs from a particular directory to a specified third-party photograph-sharing website when new photographs are added to the directory. Under these circumstances, the content management system 1000 forwards the newly added photographs to the third-party website, where authorized remote users can view them. According to another example, the user might compose an identity-based rule under which the content management system 1000 permits selected third-party users to access content in a specified folder. Again, it is noted that these identity-based rules operate with respect to the identity of the users, applications, or services as opposed to operating with respect to the computers used by these users, applications, or services. Although the invention can be practiced using identity-based rules, the content management systems of the invention can also be adapted for use with rules other than identity-based rules.

The services provided and implemented by way of the content management service 1004 may be provided on a fee basis. An exemplary fee structure may be configured to correspond to, among other things, the number of files transmitted between a client and the content management service, the bandwidth employed by a client, the number of devices associated with a client, or any other suitable parameters.

One aspect of the arrangement illustrated in FIG. 10 is that overall control of the content management needs of multiple clients associated with a particular business or operation can be coordinated through a central website, without necessitating the use, implementation or maintenance, by that business, of an expensive and complex central management system. Such of the content management service, as the potential costs to the client associated with a severance of the relation with the content management service may be significant and would likely exceed the costs associated with maintenance of that relation.

Yet another advantage of the configuration illustrated in FIG. 10 relates to computer 1012, through which remote access to data associated with one or more related clients of the content management service is achieved. In particular, a user desiring to access data contained, for example, on main office LAN 1006 can readily do so by simply connecting computer 1012 with the content management service website 1004, at which time various content management operations may be performed. Consequently, any number of remote users can readily avail themselves of desired content and content management functionality. Such a feature may prove particularly useful, for example, in the case of businesses and other enterprises that have employees who frequently travel away from the home office and rely on remote access to content.

In one such exemplary content management operation, the content management service 1004 automatically updates the content detected on the remotely connecting computer 1012. Similarly, in the event that hotspot 1010 is located at a remote location, a user employing hotspot 1010 to access and view content can be assured that the accessed content reflects the most up to date content available from the other related clients.

Directing attention now to FIG. 11, various details are provided regarding implementation of a content management system in another exemplary operating environment. In the illustrated embodiment, the operating environment comprises a LAN designated generally at 1100. In the illustrated embodiment, the LAN 1100 comprises an appliance 1102 in connection with various other computers and peripheral devices, designated generally at 1104.

In this exemplary operating environment, the content management system 1200 resides on the appliance 1102. In contrast with the arrangement illustrated in FIG. 10, the arrangement in FIG. 11 provides for all of the content management functions to be performed by the appliance 1102 and, in general, no distribution of such functionality is implemented in this exemplary arrangement. In general however, the functionality of the content management system 1102 is generally as disclosed elsewhere herein.

One advantage of the arrangement illustrated in FIG. 11 is that content management functionality can be readily implemented by businesses and/or home users that lack access to sophisticated information technology and personnel. Moreover, as suggested by the arrangements depicted in FIGS. 10, 11 and 12, embodiments of the invention are readily scalable for implementation in operating environments that may vary widely in size and scope.

As suggested above, embodiments of the content management system may be implemented within a variety of different environments. Details concerning yet another suitable operating environment for embodiments of the invention are provided in FIG. 12. In particular, embodiments of the present invention may also implemented with a special purpose or general purpose computer which may or may not comprise a portion of a computer network. As discussed in greater detail below, such a general purpose computer exemplarily includes various computer hardware. Exemplary embodiments of the present invention also comprise computer-readable media for carrying or having computer-executable instructions or electronic content structures, such as data structures, stored thereon.

Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or electronic content structures and which can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and content which cause a general purpose computer, special purpose computer, or special purpose local processing device to perform a certain function or group of functions.

The following discussion provides a brief, general description of an exemplary computing environment in which the invention may be implemented. Although not required, aspects of the invention may be described in the general context of computer-executable instructions, such as program modules, being executed by computers in network environments.

Generally, program modules include routines, programs, objects, components, and content structures that perform particular tasks or implement particular abstract content types. Computer-executable instructions, associated content structures, and program modules represent examples of the program code means for executing steps of the methods disclosed herein. The particular sequence of such executable instructions or associated content structures represent examples of corresponding acts for implementing the functions described in such steps.

Of course, the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a client network. In a distributed computing environment for example, program modules may be located in both local and remote memory storage devices.

With more particular reference now to FIG. 12, an exemplary system for implementing the invention includes a general purpose computing device in the form of a conventional computer 100, including a processing unit 102, a system memory 104, and a system bus 106 that couples various system components including system memory 104 to processing unit 102. System bus 106 may be any of several types of bus structures including a memory bus or memory controller, a peripheral bus, and a local bus using any of a variety of bus architectures. System memory 104 includes read only memory (ROM) 108 and random access memory (RAM) 110. A basic input/output system (BIOS) 112, containing the basic routines that help transfer information between elements within computer 100, such as during start-up, may be stored in ROM 108.

Computer 100 may also include a magnetic hard disk drive 114 for reading from and writing to a magnetic hard disk 116, a magnetic disk drive 118 for reading from or writing to a removable magnetic disk 120, and an optical disk drive 122 for reading from or writing to removable optical disk 124 such as a CD-ROM or other optical media. Magnetic hard disk drive 114, magnetic disk drive 118, and optical disk drive 122 are connected to system bus 106 by a hard disk drive interface 126, a magnetic disk drive interface 128, and an optical disk drive interface 130, respectively. The drives and their associated computer-readable media provide nonvolatile storage of computer-executable instructions, content structures, program modules and other content for computer 100.

Although the exemplary environment described herein employs a magnetic hard disk 116, a removable magnetic disk 120 and a removable optical disk 124, other types of computer readable media for storing content can be used, including magnetic cassettes, flash memory cards or other types of memory expansion cards, digital video disks, Bernoulli cartridges, RAMs, ROMs, and the like.

Program code means comprising one or more program modules may be stored on hard disk 116, magnetic disk 120, optical disk 124, ROM 108 or RAM 110, including an operating system 132, one or more application programs 134 capable of implementing various aspects of the methods and systems disclosed herein, other program modules 136, program content 138, content management software 140, and browser program 142.

Note that, in general, content management software 140 refers to any software effective in implementing some or all of the functionality disclosed herein. Moreover, and as disclosed elsewhere herein, aspects of content management software 140 may reside other than at computer 100 and may, instead, be distributed throughout the network wherein computer 100 is employed, or outside such network. Accordingly, the arrangement illustrated in FIG. 12 is exemplary only and is not intended to limit the scope of the invention in any way.

A user may enter commands and information into computer 100 through keyboard 141, pointing device 142, or other input devices (not shown), such as a microphone, joy stick, game pad, satellite dish, scanner, or the like. These and other input devices are often connected to processing unit 102 through a serial port interface 144 coupled to system bus 106. Alternatively, the input devices may be connected by other interfaces, such as a parallel port, a game port or a universal serial bus (USB). A monitor 146 or another display device is also connected to system bus 106 via an interface, such as video adapter 148. In addition to monitor 146, personal computers typically include other peripheral output devices (not shown), such as speakers, printers, scanners, and the like.

Computer 100 may operate in a networked environment using logical connections to one or more remote computers, such as remote computers 100A and 100B, as well as a network appliance 100C. In some embodiments, network appliance 100C may serve as an access point for computers in LAN 152 or WAN 154, for example, to access a remote server, which may or may not be in communication with a global computer network such as the Internet, whereat various aspects of the functionality disclosed herein may be implemented. Correspondingly, the network appliance 100C may likewise serve as an access point for a remote server to access devices communicating with each other by way of, for example, LAN 152 or WAN 154. In yet other embodiments, network appliance 100C may be omitted.

Remote computers 100A and 100B may each be another personal computer, a server, a router, a network PC, a peer device or other common network node, and typically includes many or all of the elements described above relative to computer 100, although only memory storage devices 150A and 150B and their associated application programs 134A and 134B have been illustrated in FIG. 12. The logical connections depicted in FIG. 12 include a local area network (LAN) 152, and Wide Area Network (WAN) 154 and other networks that typically cover a wide geographic area such as a state or country. WAN type networking environments are commonplace in office-wide or enterprise-wide computer networks, intranets and the Internet. It should be noted that embodiments of the present invention may also be employed in the context of a global computer network 300. In general, the aforementioned are exemplary operating environments and are not intended to limit the scope of the invention in any way.

When used in a LAN networking environment for example, computer 100 is connected to LAN 152 through a network interface 156. When used in a WAN 154 networking environment, computer 100 may include a modem 158, a wireless link, or other means for establishing communications over WAN 154. Modem 158, which may be internal or external to computer 100, is connected to system bus 106 via serial port interface 144. In a networked environment, program modules depicted relative to computer 100, or portions thereof, may be stored in a remote memory storage device. Of course, the network connections shown are exemplary and other means of establishing communications over LAN 152 and/or WAN 154 may alternatively be employed.

The described embodiments are to be considered in all respects only as exemplary and not restrictive. The scope of the invention is, therefore, indicated by the appended claims rather than by the foregoing description. All changes which come within the meaning and range of equivalency of the claims are to be embraced within their scope.

1. A method for managing content in a computing environment that includes a at least one computing device, the method comprising:
detecting a trigger;
identifying content with which the trigger corresponds, the content having metadata associated therewith; and
causing, in response to detection of the trigger, implementation of an action concerning the identified content.

2. The method as recited in claim 1, wherein the trigger, the identified content, and the action collectively define a rule.

3. The method as recited in claim 1, wherein the implemented action is selected from the group consisting of: uploading the identified content; downloading the identified content; sharing the identified content; copying the identified content; backing up the identified content; and encrypting the identified content.

4. The method as recited in claim 1, wherein the trigger comprises the occurrence of at least one content event.

5. The method as recited in claim 4, wherein the at least one content event comprises at least one of the following events: content creation; content receipt; content modification; content deletion; content encryption; content download; content upload; content conversion; content corruption; virus detection; establishment of communication between a local device and the computing environment; establishment of communication between a remote device and the computing environment; passage of a predetermined period of time; a user logon to a device in the computing environment; and, a user logoff from a device in the computing environment.

6. The method as recited in claim 1, further comprising examining the metadata of the identified content so as to facilitate a determination as to the particular action to be implemented.

7. A method for managing content in a computing environment that includes at least one computing device, the method comprising:
defining at least one rule concerning content management;
detecting a trigger;
identifying the content with which the trigger corresponds, the content having metadata associated therewith;
consulting the at least one rule to determine what action is required to be implemented; and
causing the implementation of the action concerning the identified content.

8. The method as recited in claim 7, wherein the at least one rule is defined in terms of an identity with respect to which the action is to be performed, wherein the identity is one of a person, an application and a service.

9. The method as recited in claim 7, wherein defining the at least one rule concerning content management comprises associating, with each other, the trigger, the identified content, and the action.

10. The method as recited in claim 9, wherein defining the at least one rule further comprises associating at least some of the metadata with the trigger and the action.

11. The method as recited in claim 7, further comprising making a determination as to whether or not any action is required to be implemented.

12. The method as recited in claim 11, wherein the action is only implemented if a determination is made that such implementation is required.

13. The method as recited in claim 7, wherein the implemented action is selected from the group consisting of: uploading the identified content; downloading the identified content; sharing the identified content; copying the identified content; backing up the identified content; and encrypting the identified content.

14. The method as recited in claim 7, wherein the trigger comprises the occurrence of at least one content event.

15. The method as recited in claim 14, wherein the at least one content event comprises at least one of the following events: content creation; content receipt; content modification; content deletion; content encryption; content download; content upload; content conversion; content corruption; virus detection; establishment of communication between a local device and the computing environment; establishment of communication between a remote device and the computing environment; passage of a predetermined period of time; a user logon to a device in the computing environment; and, a user logoff from a device in the computing environment.

16. The method as recited in claim 7, further comprising examining the metadata of the identified content so as to facilitate a determination as to the particular action to be implemented.

17. The method as recited in claim 7, further comprising exporting a copy of the at least one rule.

18. The method as recited in claim 7, further comprising importing a rule.

19. The method as recited in claim 7, further comprising determining whether the at least one rule conflicts with another rule.

20. The method as recited in claim 19, further comprising resolving any conflict determined to exist.

21. A method for managing content in a client-website environment that includes a website server configured for communication with one or more clients, the method comprising:
defining at least one rule concerning content management;
detecting at least one content event;
identifying the content with which the at least one content event corresponds, the content having metadata associated therewith;
consulting the at least one rule to determine what action is required to be implemented; and
causing the implementation of the action concerning the identified content.

22. The method as recited in claim 21, wherein the rule defines a relationship of the at least one content event, the identified content, and the action.

23. The method as recited in claim 21, wherein at least a portion of the method is performed at the website server.

24. The method as recited in claim 21, wherein at least a portion of the method is performed at one of the clients.

25. The method as recited in claim 21, wherein defining at least one rule concerning content management comprises defining a rule that applies to one of the following: a single client; and, a plurality of clients.

26. The method as recited in claim 21, wherein the at least one content event comprises at least one of the following events: content creation; content receipt; content modification; content deletion; content encryption; content download; content upload; content conversion; content corruption; virus detection; establishment of communication between a local device and the computing environment; establishment of communication between a remote device and the computing environment; passage of a predetermined period of time; a user logon to a device in the computing environment; and, a user logoff from a device in the computing environment.

27. The method as recited in claim 21, wherein the implemented action is selected from the group consisting of: uploading the identified content; downloading the identified content; sharing the identified content; copying the identified content; backing up the identified content; and encrypting the identified content.

28. The method as recited in claim 21, further comprising determining whether the at least one rule conflicts with another rule.

29. The method as recited in claim 28, further comprising resolving any conflict determined to exist.

30. A computer program product for implementing a method for managing content in a computing environment that includes at least one device, the computer program product comprising:
a computer readable medium carrying computer executable instructions for performing the method, wherein the method comprises:
detecting a trigger;
identifying content with which the trigger corresponds, the content having metadata associated therewith; and
causing, in response to detection of the trigger, implementation of an action concerning the identified content.

31. The computer program product as recited in claim 30, wherein the trigger, the identified content, and the action collectively define a rule.

32. The computer program product as recited in claim 30, wherein the implemented action is selected from the group consisting of: uploading the identified content; downloading the identified content; sharing the identified content; copying the identified content; backing up the identified content; and encrypting the identified content.

33. The computer program product as recited in claim 30, wherein the trigger comprises the occurrence of at least one content event.

34. The computer program product as recited in claim 33, wherein the at least one content event comprises at least one of the following events: content creation; content receipt; content modification; content deletion; content encryption; content download; content upload; content conversion; content corruption; virus detection; establishment of communication between a local device and the computing environment; establishment of communication between a remote device and the computing environment; passage of a predetermined period of time; a user logon to a device in the computing environment; and, a user logoff from a device in the computing environment.

35. The computer program product as recited in claim 30, further comprising examining the metadata of the identified content so as to facilitate a determination as to the particular action to be implemented.

36. A computer program product for use in facilitating content management, the computer program product comprising:
one or more computer-readable media having stored thereon a data structure, the data structure including:
at least one data field; and
a metadata profile associated with the at least one data field, and the metadata profile including:
content management metadata; and
file system metadata.

37. The computer program product as recited in claim 36, wherein the file system metadata comprises metadata concerning at least one of: file history; file attributes; and, location.

38. The computer program product as recited in claim 36, wherein the content management metadata comprises metadata concerning at least one of: actions relating to the at least one data field; and, access to the at least one data field.

39. The computer program product as recited in claim 36, wherein at least some of the metadata in the metadata profile is configured to serve as an input to a content management system.

40. The computer program product as recited in claim 36, wherein at least a portion of the data structure is configured for use as part of a data management rule.
